(19) United States
(12) Patent Application Publication
(10) Pub. No.: US 2024/0403595 A1
(43) Pub. Date: Dec. 5, 2024

(54) HUMAN COLLABORATIVE AGENT DEVICE, SYSTEM, MULTI-AGENT LEARNING METHOD, AND, STORAGE MEDIUM

(71) Applicant: Mitsubishi Electric Corporation, Tokyo (JP)

(72) Inventors: Mamoru Doi, Tokyo (JP); Toshisada Mariyama, Tokyo (JP); Kenya Sugihara, Tokyo (JP); Tadashi Onishi, Tokyo (JP)

(73) Assignee: Mitsubishi Electric Corporation, Tokyo (JP)

(21) Appl. No.: 18/802,731

(22) Filed: Aug. 13, 2024

Related U.S. Application Data
(63) Continuation of application No. PCT/JP2022/012936, filed on Mar. 22, 2022.

(51) Int. Cl. G06N 3/004

(52) U.S. Cl. CPC G06N 3/004

(57) ABSTRACT

A multi-agent learning method includes: by an agent, presenting acquired information to a human; and, by the human, correcting a behavior of the agent.

### CROSS REFERENCE TO RELATED APPLICATION

This application is a Continuation of PCT International Application No. PCT/JP2022/012936, filed on Mar. 22, 2022, which is hereby expressly incorporated by reference into the present application.

### TECHNICAL FIELD

The present disclosure relates to a multi-agent learning method.

### BACKGROUND ART

In a human-in-the-loop multi-agent reinforcement learning method described in Non-Patent Literature 1, a plurality of agents interact with each other, and moreover humans participate in it.

### CITATION LIST

### Non-Patent Literature

Non-Patent Literature 1: Jonathan Chung, Anna Luo, Xavier Raffin and Scott Perry “Battlesnake Challenge: A Multi-agent Reinforcement Learning Playground with Human-in-the-loop,” July 2020

### SUMMARY OF INVENTION

### Technical Problem

However, behaviors are not corrected in the human-in-the-loop multi-agent reinforcement learning method described above, and, in particular, behaviors are not corrected by taking in the interpretability of the behaviors. Accordingly, the human-in-the-loop multi-agent reinforcement learning method does not enable learning of desired behaviors.

An object of the present disclosure is to provide a multi-agent learning method that enables correction of behaviors, and, in particular, enables correction of behaviors by taking in the interpretability of the behaviors.

### Solution to Problem

A human collaborative agent device according to the present disclosure is a human collaborative agent device to perform multi-agent learning, including processing circuitry, in which the processing circuitry performs processes of, acquiring environmental information from environment including the human collaborative agent device; presenting information of a behavior inferred by the human collaborative agent device, information of a reason for the behavior inferred by the human collaborative agent device, or the environmental information acquired from the environment to a user who operates the human collaborative agent device, on a basis of the environmental information acquired from the environment; and acquiring information of the behavior corrected by the user, or information of the reason for the behavior corrected by the user.

### Advantageous Effects of Invention

The multi-agent learning method according to the present disclosure enables correction of behaviors, and, in particular, enables correction of behaviors by taking in the interpretability of the behaviors.

### BRIEF DESCRIPTION OF DRAWINGS

FIG. 1 is a configuration diagram of a human-in-the-loop learning system NS according to a first embodiment.

FIG. 2 is a conceptual diagram of the human-in-the-loop learning system NS according to the first embodiment.

FIG. 3 depicts interpretability in human-in-the-loop learning.

FIG. 4 depicts an inference operation (No. 1) after learning according to the first embodiment.

FIG. 5 depicts an inference operation (No. 2) after learning according to the first embodiment.

FIG. 6 is a flowchart (No. 1) depicting an operation by the human-in-the-loop learning system NS according to the first embodiment.

FIG. 7 is a flowchart (No. 2) depicting an operation by the human-in-the-loop learning system NS according to the first embodiment.

FIG. 8 is a flowchart (No. 3) depicting an operation by the human-in-the-loop learning system NS according to the first embodiment.

FIG. 9 is a flowchart (No. 4) depicting an operation by the human-in-the-loop learning system NS according to the first embodiment.

FIG. 10 depicts an overview of behaviors of hornets according to the first embodiment.

FIG. 11 depicts an overview of behaviors of honey bees according to the first embodiment.

FIG. 12 depicts an operation by a human-in-the-loop learning system NS according to a second embodiment.

FIG. 13 depicts configuration at the time of inference by the human-in-the-loop learning system NS according to the second embodiment.

FIG. 14 is a configuration diagram of the human-in-the-loop learning system NS according to the second embodiment.

FIG. 15 depicts an inference operation after learning according to the second embodiment.

### DESCRIPTION OF EMBODIMENTS

Embodiments of a human-in-the-loop learning system according to the present disclosure are explained.

### First Embodiment

### First Embodiment

A human-in-the-loop learning system NS according to a first embodiment is explained.

### Configuration According to First Embodiment

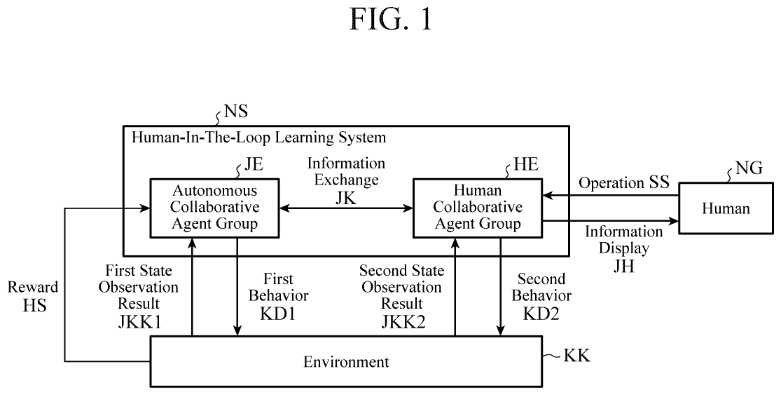

FIG. 1 is a configuration diagram of the human-in-the-loop learning system NS according to the first embodiment.

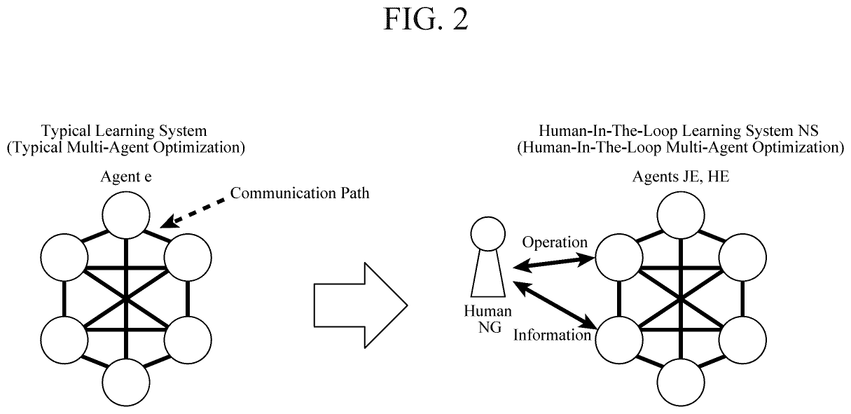

FIG. 2 is a conceptual diagram of the human-in-the-loop learning system NS according to the first embodiment.

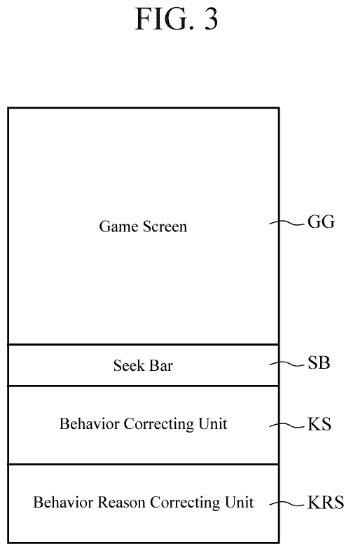

FIG. 3 depicts interpretability in human-in-the-loop learning.

As depicted in FIG. 2, humans NG participate in the human-in-the-loop learning system NS (human-in-the-loop multi-agent optimization) according to the first embodiment unlike in typical learning systems (typical multi-agent optimization).

The human-in-the-loop learning system NS according to the first embodiment handles interpretability (e.g. interpretability learned by human-in-the-loop learning depicted in the following document (depicted in FIG. 3)).

Christian Arzate Cruz and Takeo Igarashi “Interactive Explanations: Diagnosis and Repair of Reinforcement Learning Based Agent Behaviors”

The human-in-the-loop learning system NS according to the first embodiment is an aspect of multi-agent learning systems.

As depicted in FIG. 1, the human-in-the-loop learning system NS includes an autonomous collaborative agent group JE and a human collaborative agent group HE. Hereinbelow, both the autonomous collaborative agent group JE and the human collaborative agent group HE are collectively referred to as “agent groups E,” in some cases.

The agent groups E acquire information from an environment KK, and learns the information.

Here, the environment KK generally means a field where the agent groups E exhibit behaviors such as movements. The environment KK returns values (synonymous with rewards or penalties) as responses to the behaviors. For example, in a game of a play, the game itself is the environment KK, and also, in driving of an automobile, all locations where the automobile can move are the environment KK.

The autonomous collaborative agent group JE learns and infers in collaboration with the human collaborative agent group HE. The human collaborative agent group HE receives an operation SS from the humans NG, and performs information display JH for the humans NG. In a case where the humans NG do not perform the operation SS at all as in a case of inference, the human collaborative agent group HE and the autonomous collaborative agent group JE are identical.

In the human-in-the-loop learning system NS, the autonomous collaborative agent group JE and the human collaborative agent group HE interact with the environment KK and the humans NG.

The humans NG perform the operation SS in at least one agent group of the autonomous collaborative agent group JE and the human collaborative agent group HE.

As for the relationship between the humans NG and the agent groups E, one human NG may operate a plurality of agent groups E, one human NG may operate one agent group E, a plurality of humans NG, each of whom is assigned a different role, may operate a plurality of agent groups E, a plurality of humans NG may operate one agent group E, or a plurality of humans NG may operate a plurality of agent groups E.

The human-in-the-loop learning system NS may be one computer including the autonomous collaborative agent group JE and the human collaborative agent group HE, and also may be a set of a computer to implement the autonomous collaborative agent group JE, and a computer to implement the human collaborative agent group HE. That is, the number of computers may be one, or each of the autonomous collaborative agent group JE and the human collaborative agent group HE may retain one computer. In addition, one computer may complete operations of the human-in-the-loop learning system NS, and also a plurality of robots that are moved by microcomputers or the like may implement the human-in-the-loop learning system NS.

Note that the human collaborative agent group HE that is operated by humans is information processing equipment having a learning function implemented by a computer.

As depicted in FIG. 3, learning handled by the human-in-the-loop learning system NS is a system for which humans can correct behaviors and behavior reasons. There is a game screen GG. A correction target is searched for by using a seek bar SB. Behaviors that the agent group E can exhibit are displayed by a behavior correcting unit KS. Thereby, a behavior can be selected from the behaviors, and corrected. A behavior reason correcting unit KRS enables correction of a behavior reason by selection of reason correction using a tab.

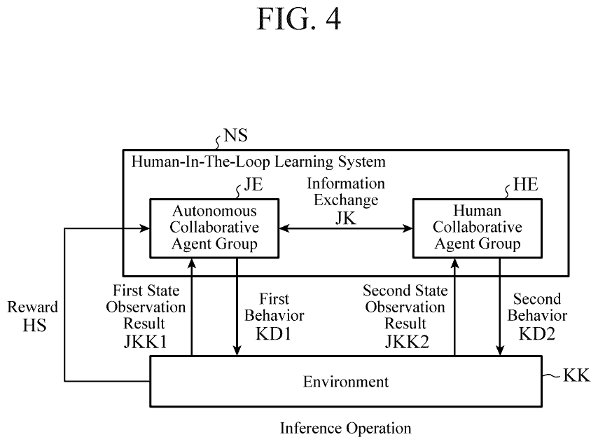

FIG. 4 depicts an inference operation (No. 1) after learning according to the first embodiment.

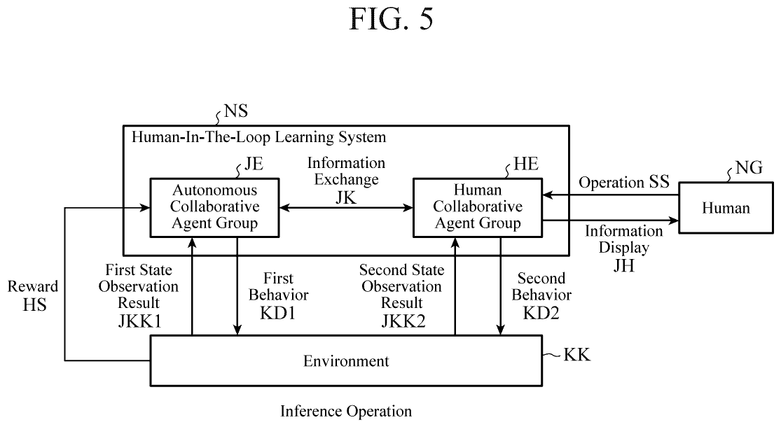

FIG. 5 depicts an inference operation (No. 2) after learning according to the first embodiment.

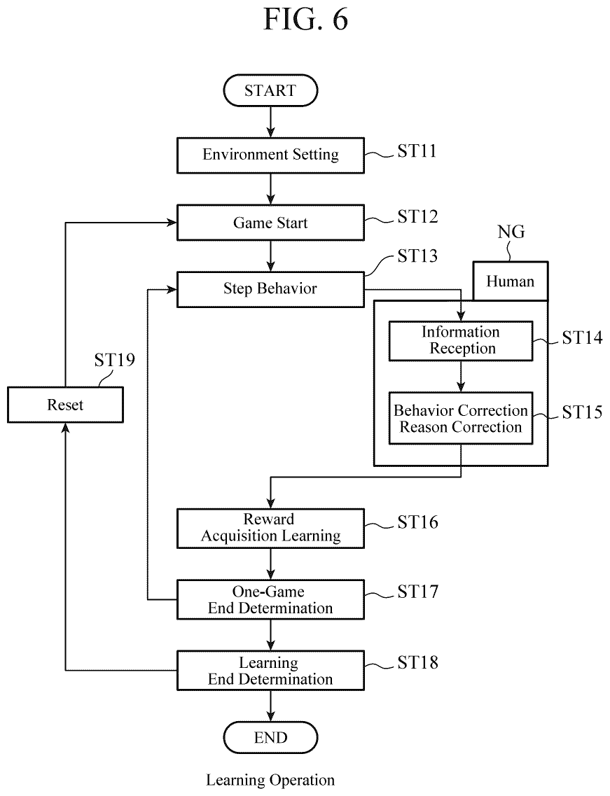

FIG. 6 is a flowchart (No. 1) depicting an operation by the human-in-the-loop learning system NS according to the first embodiment.

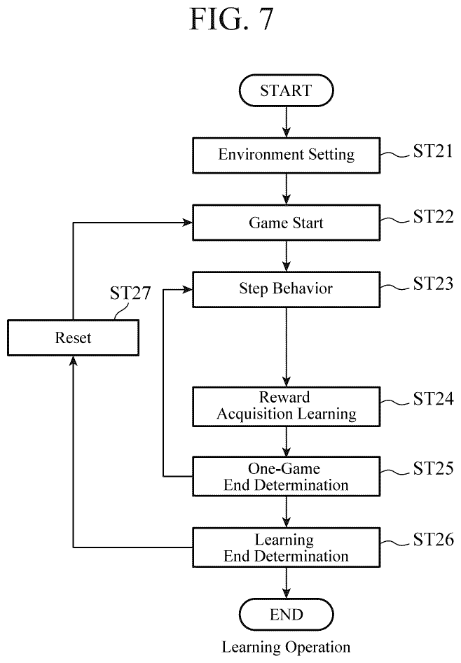

FIG. 7 is a flowchart (No. 2) depicting an operation by the human-in-the-loop learning system NS according to the first embodiment.

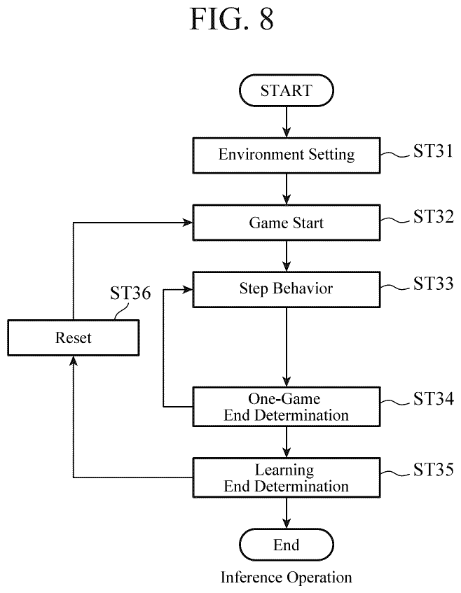

FIG. 8 is a flowchart (No. 3) depicting an operation by the human-in-the-loop learning system NS according to the first embodiment.

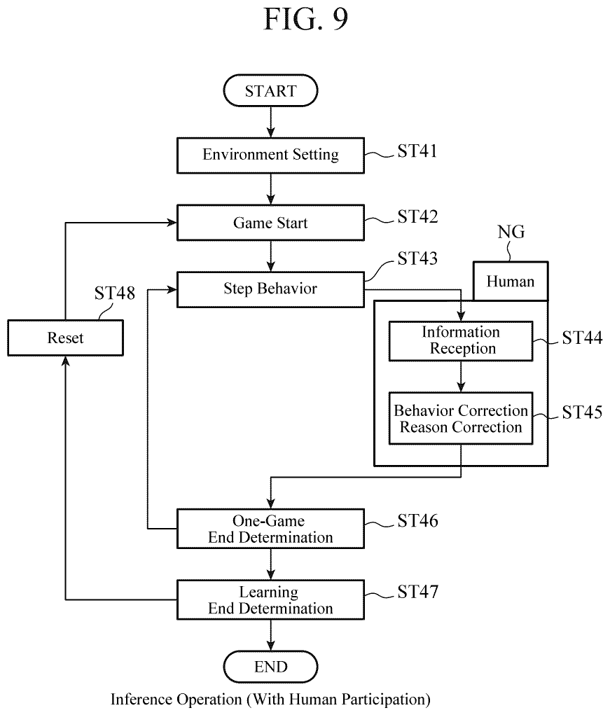

FIG. 9 is a flowchart (No. 4) depicting an operation by the human-in-the-loop learning system NS according to the first embodiment.

For example, the human-in-the-loop learning system NS according to the first embodiment implements behaviors autonomously when the humans NG are not participating. On the other hand, in the human-in-the-loop learning system NS according to the first embodiment, for example at the time of training of a human NG (e.g. at the time of a training simulator), the human NG performs operations SS, and the agent groups E respond to the operations SS, and exhibit behaviors with reference to information obtained from the environment KK, similarly to the time of learning.

As suggested by FIGS. 4 and 5, in the human-in-the-loop learning system NS according to the first embodiment, the agent groups E aggregate acquirable information (e.g. information that can be obtained from the environment KK, information exchanged between the agent groups E) in such a manner that a human NG can understand the information visually; on the other hand, the human NG performs an operation SS on the basis of the aggregated information.

In a case of a battle screen of hornets and honey bees, the fields of view shared by the honey bees can be displayed, but fields outside the fields of view cannot be displayed. Accordingly, the honey bees decide behaviors by watching a screen on which the hornets are not displayed.

In the situation setting described above, a human NG selects a movement a specified agent group E should make next on the basis of behaviors inferred by the agent groups E and information (depicted in FIG. 5). Due to the selection, the efficiency of learning can be enhanced.

The human-in-the-loop learning system NS uses a behavior optimization scheme (e.g. multi-agent reinforcement learning, Monte Carlo tree search, Bayesian optimization, model predictive control).

The autonomous collaborative agent group JE decides behaviors by a rule-based scheme, a behavior optimization scheme, or a combination of these two schemes.

At this time, it is possible also to harmoniously use a plurality of types of behavior optimization schemes simultaneously. The role of each agent group E may be different from the role of the other agent group E (e.g. placing emphasis on searches, placing emphasis on attacks), heterogeneous (of different natures, of different types) (e.g. quadrotors and ground vehicles) in which physical properties of each agent group E may be different (e.g. speeds are different), or each agent group E may be of a different hierarchy (decision of strategies, decision of behaviors).

The agent groups E interact with each other because the interaction between the agent groups E is described or because there are a plurality of the agent groups E in the environment KK. Because of this, it becomes possible to cause behaviors to be reflected entirely by correcting behaviors of part of the agent groups E.

The humans NG need not participate all the time, but, for example, the agent groups E may be made autonomous in some time periods; on the other hand, the humans NG may participate in some other time periods.

By introducing a seek bar for behaviors, behaviors may be corrected when points at which corrections should be made are discovered.

By storing behaviors and states corrected by the humans NG in a memory, and using them as an experience buffer for learning, it becomes possible for the agent groups E to share the experience buffer, and it becomes possible to accelerate learning.

At the time of inference, behaviors are decided without using the buffer. Interpretability can be presented on the basis of information stored in the memory. A state which is the same as or closer to the current state is searched for, and it is presented what type of behavior a human NG has exhibited, so that the interpretability of the behavior is given. At that time, the human NG may store a verbalized operation reason in learning.

As for the autonomous collaborative agent group JE also, interpretability is given by using information in a memory of the human collaborative agent group HE.

It is also possible to present grounds explaining why determinations by humans NG are wrong by using results of learning. In a case of a training simulator or the like, such presentation is necessary for calibration of ways of thinking, in some cases. In view of this, a case where determinations by humans NG are wrong is mentioned.

### Advantages of First Embodiment

As mentioned above, in the human-in-the-loop learning system NS according to the first embodiment, by allowing the humans NG to operate at the stage of learning, the interrelationship between the agent groups E is used, and this can accelerate the learning.

In addition, in the human-in-the-loop learning system NS according to the first embodiment, when interpretability is necessary, a human NG performs an operation SS of part of the agent groups E in reinforcement learning, and gives an interpretation, so that the learning can be accelerated. Furthermore, a comment about a reason for the operation SS is added, and this enables learning of the interpretability of the reinforcement learning in a verbalized state.

By allowing the humans NG to participate at the stage of learning, it is possible to make the learning efficient while correcting errors of interpretations in the human-in-the-loop learning system NS.

Even with agent groups E with different roles, it is possible to make learning efficient by allowing the humans NG to be responsible for a role of part of the agent groups E.

In FIGS. 6 to 9, for example, activation of a game or the like is performed in environment setting.

In FIG. 6, at the time of learning, a step behavior is performed from the start of a game at Step ST12 until the end of one game after determination at Step ST17. Here, one game is so-called one episode.

As mentioned above, the human collaborative agent group HE requests humans to correct operations. In contrast, as mentioned above, the autonomous collaborative agent JE exhibits behaviors, without passing information to humans, allowing humans to correct behaviors, and so on.

In a case of a game, the human collaborative agent group HE and the autonomous collaborative agent group JE are characters who move on the same game screen. The ratio between the human collaborative agent group HE and the autonomous collaborative agent group JE that are used depends on problem setting.

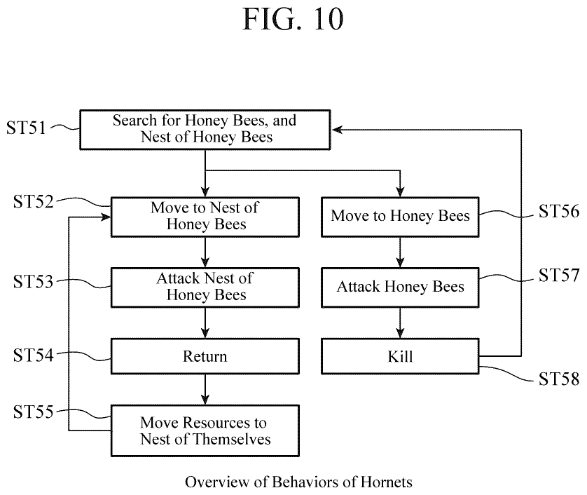

For example, in the example depicted in FIG. 10, in a case where multi-agent reinforcement learning of honey bees is performed, one honey bee may operate as the human collaborative agent (group) HE, and the rest may operate as autonomous collaborative agents (group) (JE). In addition, all of the honey bees may operate as the human collaborative agent group HE. Furthermore, some or all of the honey bees may operate as the human collaborative agent group HE, some or all of the hornets may operate as the human collaborative agent group HE, and the rest may operate as rules or the autonomous collaborative agent group JE.

One that performs operations in FIG. 6 is the human collaborative agent group HE. One that performs operations in FIG. 7 is the autonomous collaborative agent group JE. At the time of a step behavior, at Steps ST14 and ST15 in FIG. 6, the human collaborative agent group HE passes information to a human, allows her/him to correct a behavior and a behavior reason, and operates with the corrected behavior. The human collaborative agent group HE implements learning by receiving a reward for the behavior. This is repeated until one episode ends. When the one episode ends, the game is reset, and the game is repeated until the learning ends.

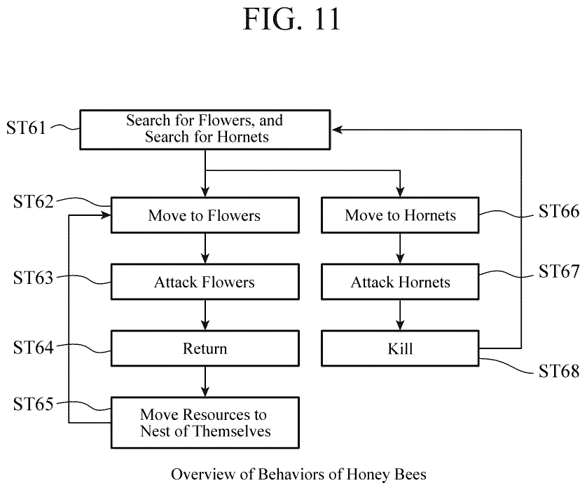

Assuming that learning of a hornet is performed, what is learned is what type of behavior one should exhibit in response to a given state in order to be able to exhibit a behavior similar to that in FIG. 11. This is repeated until the learning is completed. Assuming that learning of behaviors of a honey bee is performed, what is learned is what type of behavior one should exhibit in response to a given state in order to be able to exhibit a behavior similar to that in FIG. 11.

At the time of inference, there are patterns of FIG. 8 and FIG. 9 regarding the human collaborative agent group HE also. The autonomous collaborative agent group JE exhibits a behavior as depicted in FIG. 8. Basically, the difference from the case of learning is that, but inference for one game is required without learning of a plurality of episodes. In FIG. 8, similarly to the autonomous collaborative agent group JE, the human collaborative agent group HE also decides behaviors in an autonomous state. In FIG. 9, the human collaborative agent group HE makes a behavior decision from an environment as a state, and corrects a behavior by passing information to a human. The autonomous collaborative agent group JE makes a behavior decision from an environment as a state without passing information to a human.

### <Supplementary Explanation>

FIG. 10 depicts an overview of behaviors of hornets according to the first embodiment.

FIG. 11 depicts an overview of behaviors of honey bees according to the first embodiment.

The overviews of behaviors depicted in FIG. 10 and FIG. 11 are the content of step behaviors (FIG. 6 to FIG. 9).

In a case where hornets are learning targets, all agents E are the human collaborative agent groups HE, or all agents E are the autonomous collaborative agent groups JE. In addition, in a case where learning is proceeded with by requesting a human to make corrections, and in a case where learning is proceeded with in a manner of autonomous in the human collaborative agent group HE, all agents E are the autonomous collaborative agent groups JE. In either case of learning and inference, behaviors of Steps ST51 to ST58 are exhibited. Specifically, depending on situations, an attack on a nest of honey bees or an attack on honey bees is selected.

In a case where honey bees are learning targets, all agents E are the human collaborative agent groups HE, or all agents E are the autonomous collaborative agent groups JE. In addition, in a case where learning is proceeded with by requesting a human to make corrections, and in a case where learning is proceeded with in a manner of autonomous in the human collaborative agent group HE, all agents E are the autonomous collaborative agent groups JE. In either case of learning and inference, behaviors of Steps ST61 to ST68 are exhibited. Specifically, depending on situations, an attack on flowers or an attack on hornets is selected.

In more detail, hornets obtain resources by attacking honey bees or a nest of the honey bees. The honey bees obtain resources from flowers. Either the hornets or the honey bees win when the resources they obtained reach a certain amount. The goal of the honey bees is to ensure the resources while interfering with the hornets. The goal of the hornets is to ensure the resources while avoiding the interference from the honey bees.

A “behavior” (a behavior in one turn) is to move up, down, leftward, or rightward or to attack (e.g. in a case of the hornets, to move to the honey bees or to the nest of the honey bees or to attack, and in a case of the honey bees, to move to the hornets or the flowers or to attack), or to supply the resources.

For example, a “reason for a behavior” is “for approaching and attacking the opponents to interfere with them,” or “for returning to the nest after attacking and obtaining the resources.”

Both the hornets and the honey bees need to exhibit behaviors in collaboration among a plurality of them. There is a possibility that a behavior of the hornets and a behavior of the honey bees appears to be not good at a glance at that moment, but learning is performed while giving reasons such as “for going behind the opponents.” The reasons for behaviors are presented at the time of inference, and treated as interpretability.

On the basis of information presented by an agent group E, a human NG decides what type of behavior she/he would exhibit in a case of her/himself, and a reason for the behavior, and inputs them as a behavior and interpretability of the agent group E, so that the learning is accelerated.

### Second Embodiment

### Second Embodiment

A human-in-the-loop learning system NS according to a second embodiment is explained.

The human-in-the-loop learning system NS according to the first embodiment is configured minimally; on the other hand, it is assumed in the second embodiment that learning including interpretability is performed.

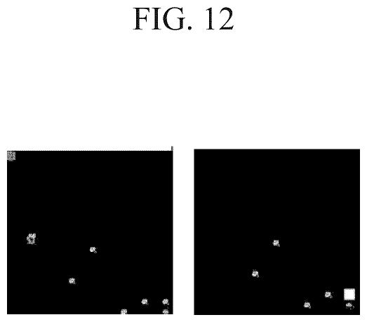

FIG. 12 depicts an operation by the human-in-the-loop learning system NS according to the second embodiment.

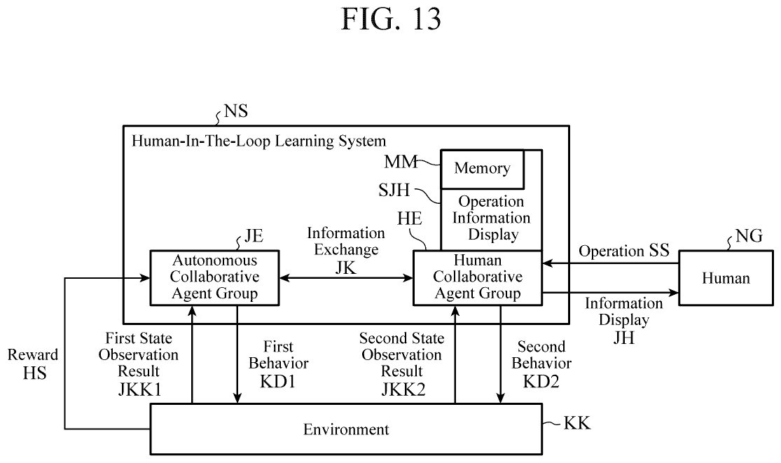

FIG. 13 depicts configuration at the time of inference by the human-in-the-loop learning system NS according to the second embodiment.

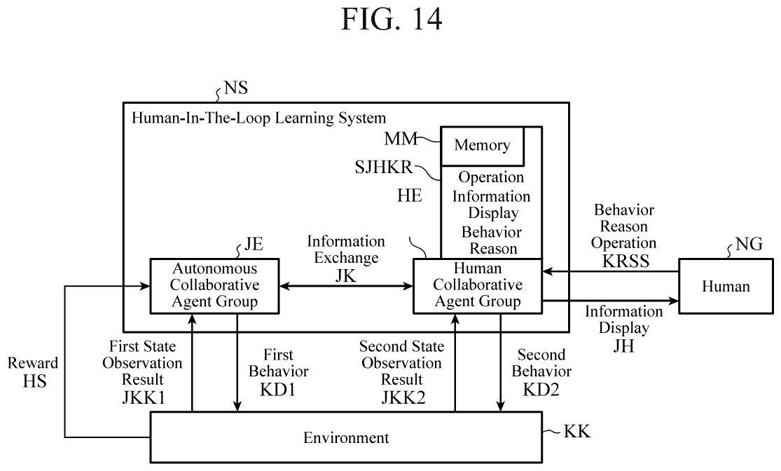

FIG. 14 is a configuration diagram of the human-in-the-loop learning system NS according to the second embodiment.

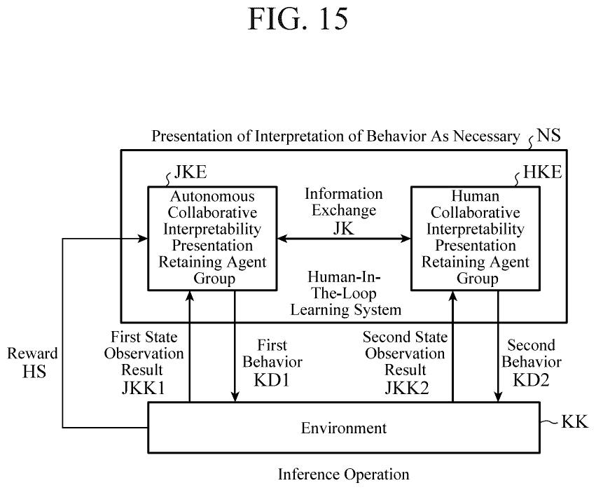

FIG. 15 depicts an inference operation after learning according to the second embodiment.

An agent group E presents behaviors, reasons for behaviors, and information display. In response to the presentation, a human NG corrects a behavior by an operation. The human NG can further correct a reason for a behavior. The reasons for the behaviors that the agent group E presents to the human NG may be visual information or may be sentences. The agent group E generates visual information or sentences as interpretations of behaviors of itself.

A human collaborative agent group HE decides behaviors autonomously without input from humans NG similarly to an autonomous collaborative agent group JE. For presentation of reasons for behaviors, a rule-based approach (which can be expressed as being rule-based by using a decision tree or a format conforming thereto it by learning), point-of-interest extraction (e.g. LIME, Grad-CAM, CAM, Attention, Transformer), and a sentence generation learning approach (LSTM-RNN, Auto Encoder, Transformer) are used.

For example, it is assumed that, in FIG. 5, a behavior of an agent group E is to be decided, and information “ensuring a wide field of view for searching; for this purpose, move up” is displayed. A human NG inputs a reason for correction and a corrected behavior in a case where she/he makes a correction. By storing information and the behavior after the correction in a memory, it is aimed to enhance learning of interpretability, and to enhance learning of behaviors.

As explained with reference to the first embodiment, by additionally presenting also information having been stored in a memory when presenting interpretability at the time of inference, it becomes possible to give interpretations with greater amounts of information as compared to typical systems, by displaying information as to how humans NG made determinations at the time of learning, reasons, and the content of behaviors.

In particular, in multi-agent learning reinforcement learning, learning is performed for each agent group E. Multi-agent Q-learning, SARSA learning, multi-agent DeepQ learning, multi-agent DDPG learning, Multi-Agent Monte Carlo Tree Search, a mechanism retaining an attention module, learning using Actor Critic, the content described in reference algorithms, or learning combining what are described above (ensemble learning, and a learning scheme different for each agent group E) is included.

For example, the reference algorithms are as follows.

(1) Multi-Agent Learning with Deep Reinforcement Learning | GMO Internet Group, Inc. Next Generation System Laboratory
All the multi-agent learning schemes that are mentioned regarding experiments
   (2) Overview of Multi-Agent Reinforcement Learning (tcom242242.net)
Algorithm of multi-agent reinforcement learning, algorithm of multi-agent deep reinforcement learning
   (3) Multi-Agent Learning with Deep Reinforcement Learning (first part) (slideshare.net), Multi-Agent Learning with Deep Reinforcement Learning (second part) (slideshare.net)
Multi-agent reinforcement learning scheme, MADDPG, etc.

### Advantage of Second Embodiment

As mentioned above, in the human-in-the-loop learning system NS according to the second embodiment, interpretations with greater amounts of information as compared to typical systems can be given.

The embodiments mentioned above may be combined with each other within the scope not departing from the gist of the present disclosure, and also constituent elements in each embodiment may be deleted, be changed or have other additional constituent elements as appropriate.

### INDUSTRIAL APPLICABILITY

The multi-agent learning method according to the present disclosure can be used for correction of behaviors after taking in the interpretability of the behaviors.

### REFERENCE SIGNS LIST

HE: human collaborative agent group; JE: autonomous collaborative agent group; KK: environment; NS: human-in-the-loop learning system; SS: operation

1. A human collaborative agent device to perform multi-agent learning,
comprising processing circuitry, wherein
the processing circuitry performs processes of,
acquiring environmental information from environment including the human collaborative agent device;
presenting information of a behavior inferred by the human collaborative agent device, information of a reason for the behavior inferred by the human collaborative agent device, or the environmental information acquired from the environment to a user who operates the human collaborative agent device, on a basis of the environmental information acquired from the environment; and
acquiring information of the behavior corrected by the user, or information of the reason for the behavior corrected by the user.

2. The human collaborative agent device according to claim 1, wherein the presenting includes presenting to the user using visual information.

3. The human collaborative agent device according to claim 1, wherein the presenting includes presenting to the user using a sentence.

4. The human collaborative agent device according to claim 3, wherein the presenting includes presenting the information of the reason for the behavior inferred by the human collaborative agent device, using the sentence.

5. The human collaborative agent device according to claim 1, wherein the processing circuitry performs a process of interacting with a different agent device from the human collaborative agent device among an agent group with each other in such a way as to reflect the information of the behavior corrected by the user, or the information of the reason for the behavior corrected by the user on the agent group including the human collaborative agent device.

6. The human collaborative agent device according to claim 1, wherein the processing circuitry performs a process of storing, in a memory, at least one of: the information of the behavior inferred by the human collaborative agent device, the information of the reason for the behavior inferred by the human collaborative agent device, the environmental information, the information of the behavior corrected by the user, and the information of the reason for the behavior corrected by the user.

7. The human collaborative agent device according to claim 6, wherein the processing circuitry performs a process of presenting at least one of: the information of the behavior inferred by the human collaborative agent device, the information of the reason for the behavior inferred by the human collaborative agent device, the environmental information, the information of the behavior corrected by the user, and the information of the reason for the behavior corrected by the user stored in the memory, and information related to interpretation of inference by the human collaborative agent device.

8. The human collaborative agent device according to claim 6, wherein the memory is shared by the agent group including the human collaborative agent device.

9. The human collaborative agent device according to claim 1, wherein the processing circuitry performs a process of learning autonomously without an operation by the user on a basis of the environmental information acquired from the environment.

10. The human collaborative agent device according to claim 9, wherein the processing circuitry performs a process of switching from autonomous learning to human collaborative learning on a basis of an operation by the user.

11. The human collaborative agent device according to claim 1, wherein the human collaborative agent device has a different role from that of an agent device which is different from the human collaborative agent device among an agent group including the human collaborative agent device.

12. The human collaborative agent device according to claim 1, wherein the processing circuitry performs a different process of learning from that of an agent device which is different from the human collaborative agent device among an agent group including the human collaborative agent device.

13. The human collaborative agent device according to claim 1, wherein the multi-agent learning is multi-agent reinforcement learning.

14. The human collaborative agent device according to claim 1, wherein the processing circuitry performs a process of learning and inferring in collaboration with an agent device which is different from the human collaborative agent device among an agent group including the human collaborative agent device.

15. A system comprising:
the human collaborative agent device according to claim 1; and
an agent group to exchange information with the human collaborative agent device.

16. A multi-agent learning method of a human collaborative agent device to perform multi-agent learning, comprising:
acquiring environmental information from environment including the human collaborative agent device;
presenting information of a behavior inferred by the human collaborative agent device, information of a reason for the behavior inferred by the human collaborative agent device, or the environmental information acquired from the environment to a user who operates the human collaborative agent device, on a basis of the environmental information acquired from the environment; and
acquiring information of the behavior corrected by the user, or information of the reason for the behavior corrected by the user.

17. A non-transitory computer readable storage medium storing a program to be executed by processing circuitry of a human collaborative agent device to perform multi-agent learning,
the program to enable the processing circuitry to perform processes of,
acquiring environmental information from environment including the human collaborative agent device;
presenting information of a behavior inferred by the human collaborative agent device, information of a reason for the behavior inferred by the human collaborative agent device, or the environmental information acquired from the environment to a user who operates the human collaborative agent device, on a basis of the environmental information acquired from the environment; and
acquiring information of the behavior corrected by the user, or information of the reason for the behavior corrected by the user.
